(19) United States
(12) Patent Application Publication
(10) Pub. No.: US 2022/0324091 A1
(43) Pub. Date: Oct. 13, 2022

(54) COMBINATION TOOL

(71) Applicants: Hangzhou United Tools Co., Ltd., Hangzhou City (CN); Hangzhou Great Star Industrial Co., Ltd., Hangzhou City (CN)

(72) Inventor: Yueming LI, Hangzhou City (CN)

(21) Appl. No.: 17/829,757

(22) Filed: Jun. 1, 2022

Related U.S. Application Data
(63) Continuation of application No. 17/707,573, filed on Mar. 29, 2022.
Application No. 17/707,573 is a continuation-in-part of application No. PCT/CN2019/113219, filed on Oct. 25, 2019.

(51) Int. Cl. B25F 1/02; G01B 3/10; B26B 5/00; B44D 3/16; B25D 1/00; B25G 1/08; B25B 15/00

(52) U.S. Cl. CPC B25F 1/02; G01B 3/10; B26B 5/00; B44D 3/164; B25D 1/00; B25G 1/08; B25B 15/00

(57) ABSTRACT

A multifunctional scraper includes a scraper blade (1) and a handle (2) coupled to the scraper blade (1). The multifunctional scraper further includes a second tool (4), and the handle (2) is provided with a tool receptacle (3) adapted to the second tool (4) in terms of shape and size. The second tool (4) is movably inserted in the tool receptacle (3). The multifunctional scraper, while not compromising the grip feel or outer appearance of the scraper handle (2), through providing the tool receptacle (3) that can accommodate another object such as the second tool (4) such as a screwdriver bit (21), a knife blade (22) or a tape measure (46) in the handle (2), integrates the functions of different tools into a single scraper, achieving usability of the scraper in multifunctional applications and facilitating carrying and use of an operator.

### FIELD OF THE INVENTION

This application relates to the field of hand tools and, in particular, to a multifunctional combination tool.

### DESCRIPTION OF THE PRIOR ART

To the fields of engineering construction, building decoration, etc, various hand tools like scrapers are indispensable. Scrapers, also known as putty knives, are hand tools commonly used by painters and plasterers. With scraping, shoveling, spreading and caulking capabilities, scrapers are widely used in building construction and in our daily lives. A conventional scraper is typically composed of a scraper blade and a handle fixedly coupled thereto. The scraper blade is typically a rigid material and serves as the scraper's primary working part, whilst the handle is for gripping by an operator. Existing scrapers typically have only the basic scraping or shoveling capabilities. In practice, for a surface being worked upon where there is a screw or other fixed obstacle needing to be removed, the operator typically needs to resort to a screwdriver bit, knife blade, crowbar or other tool to perform the obstacle removal or surface cleaning task. This requires the operator to carry a comprehensive set of various hand tools and search for different tools from time to time during operation, not only creating inconvenience of tool carrying but also affectting operating convenience, speed and thus affecting operating efficiency.

Therefore, those skilled in the art are directing their effort toward developing a multifunctional scraper tool integrating tools having other functions.

### SUMMARY OF THE INVENTION

In view of the above described shortcomings of the prior art, this application aims to impart, through improving the structures of existing scrapers, multifunctional effects to them.

This application provides a combination tool comprising: a first tool component, the first tool component comprising, coupled to each other, a working portion and a grip portion; and a second tool component, the second tool component detachably mounted on the grip portion of the first tool component.

In some embodiments, optionally, the grip portion is provided with a tool receptacle, and the second tool component is detachably disposed in the tool receptacle.

In some embodiments, optionally, a damping mechanism is additionally included for preventing the second tool component from accidentally disengaging from the first tool component.

In some embodiments, optionally, the damping mechanism comprises a protrusion disposed on at least one inner wall of the tool receptacle so that when the second tool is inserted in the tool receptacle, it can be stopped by the protrusion.

In some embodiments, optionally, the damping mechanism comprises an anti-slip coating provided on at least one inner wall of the tool receptacle.

In some embodiments, optionally, the damping mechanism comprises a magnetic element embedded in the grip portion.

In some embodiments, optionally, the damping mechanism comprises an elastic mechanism provided on the second tool so that when the second tool is inserted in the tool receptacle, the elastic mechanism can abut against an inner wall of the tool receptacle to prevent the second tool from accidentally disengaging from the tool receptacle.

In some embodiments, optionally, the first tool component is a scraper, the working portion is a scraper blade, the grip portion is a handle and the grip portion is secured to a leading end of the working portion.

In some embodiments, optionally, the tool receptacle is provided in a side surface of the grip portion.

In some embodiments, optionally, the tool receptacle is in a flat shape.

In some embodiments, optionally, the second tool is a Phillips bit or a knife blade, and is configured to be retractably disposed in the tool receptacle.

In some embodiments, optionally, the tool receptacle is provided, around an externally exposed end thereof, with a depression for facilitating retraction of the second tool.

In some embodiments, optionally, the depression assumes a shape corresponding to fingers.

In some embodiments, optionally, the tool receptacle has a long arm extending longitudinally on a surface of the grip portion and a short arm extending transversely toward the interior of the grip portion, forming an L-shaped cavity.

In some embodiments, optionally, the second tool is an L-shaped bit or a hammer.

In some embodiments, optionally, the tool receptacle transversely extends through the grip portion.

In some embodiments, optionally, the tool receptacle is provided at a trailing end of the grip portion.

In some embodiments, optionally, the tool receptacle is a longitudinal cavity that is open at the trailing end of the grip portion.

In some embodiments, optionally, an end cap is additionally included, the end cap openably and closably mounted at an opening of the tool receptacle.

In some embodiments, optionally, the second tool is a linear bit.

In some embodiments, optionally, the second tool is a tape measure.

The present application also provides a multifunctional scraper comprising a scraper blade and a handle coupled to the scraper blade. The multifunctional scraper further comprises a second tool, and the handle is provided with a tool receptacle. The tool receptacle is adapted to the second tool in terms of shape and size. The second tool is movably inserted in the tool receptacle.

Optionally, the tool receptacle is provided therein with a damping mechanism.

Optionally, the damping mechanism is an anti-slip silicone coating, or a protruding snap element, or a magnetic element.

Optionally, the damping mechanism is provided on at least one inner wall of the tool receptacle.

Optionally, the damping mechanism is provided at the bottom of the tool receptacle.

Optionally, the magnetic element is magnetic steel.

Optionally, the second tool is a Phillips screwdriver bit or a knife blade.

Optionally, the tool receptacle is provided in a middle portion of the handle.

Optionally, the second tool is a linear screwdriver bit.

Optionally, the tool receptacle transversely extends through the handle.

Optionally, the handle is provided, at a trailing end thereof, additionally with a longitudinal tool receptacle and an end cap. In a cavity delimited by the longitudinal tool receptacle and the end cap, the linear screwdriver bit is placed.

Optionally, the end cap is attached to the handle threadedly or by means of an elastic element.

Optionally, the second tool is an L-shaped bit tool.

Optionally, the second tool is a hammer, the hammer defining at both ends respectively a hammer working portion and a screwdriver bit.

Optionally, the tool receptacle is provided, around its externally exposed end, with a curved depression.

Optionally, the tool receptacle is provided at the trailing end of the handle.

Optionally, the second tool is a tape measure.

The above described multifunctional scraper, apart from the basic scraping and shoveling capabilities of common scrapers, while not compromising the grip feel or outer appearance, through providing the tool receptacle for accommodating the second tool in the handle, integrates the second tool into a single scraper, achieving usability of the scraper in multifunctional applications and facilitating carrying and use of an operator.

Below, the concept, structural details and resulting technical effects of this application will be further described with reference to the accompanying drawings to provide a full understanding of the objects, features and effects of this application.

### BRIEF DESCRIPTION OF THE DRAWINGS

FIG. 1 is a schematic diagram of the structure of a multifunctional scraper of an embodiment of the present application;

FIG. 2 is a schematic exploded view of the structure of a multifunctional scraper of another embodiment of the present application;

FIG. 3 is a side cutaway view of the multifunctional scraper of FIG. 2;

FIG. 4 is a schematic diagram of the structure of a Phillips screwdriver bit included in the multifunctional scraper of FIG. 2;

FIG. 5 is a schematic exploded view of the structure of a multifunctional scraper of a further embodiment of the present application;

FIG. 6 is a schematic diagram of the structure of a multifunctional scraper of a further embodiment of the present application;

FIG. 7 is a schematic exploded view of the structure of the multifunctional scraper of FIG. 6;

FIG. 8 is a side cutaway view of the multifunctional scraper of FIG. 6;

FIG. 9 is a schematic diagram of the structure of a first linear screwdriver bit included in the multifunctional scraper of FIG. 6;

FIG. 10 is a schematic diagram of the structure of a multifunctional scraper of a further embodiment of the present application;

FIG. 11 is a side cutaway view of the multifunctional scraper of FIG. 10;

FIG. 12 is a schematic diagram of the structure of an L-shaped bit tool included in the multifunctional scraper of FIG. 10;

FIG. 13 is a schematic cutaway view of the structure of a multifunctional scraper of a further embodiment of the present application;

FIG. 14 is a schematic diagram of the structure of a hammer included in the multifunctional scraper of FIG. 13; and

FIG. 15 is a schematic diagram of the structure of a multifunctional scraper of a further embodiment of the present application.

### DETAILED DESCRIPTION OF THE PREFERRED EMBODIMENTS

Below, the drawings accompanying this specification are referenced to introduce many preferred embodiments of the present application so that the techniques disclosed herein become more apparent and better understood. The present application may be embodied in many different forms of embodiment, and the protection scope of the present application is not limited only to the embodiments mentioned herein.

Throughout the accompanying drawings, structurally identical parts are indicated with identical reference numerals, and structurally or functionally similar components are indicated with similar reference numerals. The size and thickness of each component in the drawings are arbitrarily depicted, and the present application is not limited to any size or thickness of each component. For greater clarity of illustration, the thicknesses of some parts are exaggerated as appropriate somewhere in the drawings.

This application provides a combination tool including a first tool component and a second tool component. The first tool component includes, coupled to each other, a working portion and a grip portion. The grip portion is provided with a tool receptacle, and the second tool component is detachably disposed in the tool receptacle. Additionally, the combination tool may further include a damping mechanism for preventing the second tool component from accidentally disengaging from the first tool component. Below, the combination tool of the present application will be described with a scraper as the first tool component as an example.

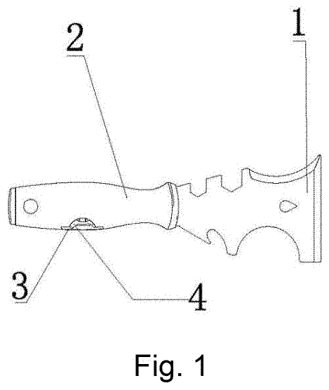

Referring to FIG. 1, a schematic diagram showing the structure of a multifunctional scraper of an embodiment of the present application, this application provides a multifunctional scraper, the multifunctional scraper including a scraper blade 1 and a handle 2 fixedly coupled to the scraper blade 1. The scraper blade 1 is used to achieve a scraping or shoveling function of the multifunctional scraper, is a primary working part of the multifunctional scraper, and is typically made from a metallic or ceramic material. For example, the metallic material may be an aluminum alloy, aluminum or steel material. The handle 2 may be typically divided into a wooden, plastic, ceramic or steel handle, and the handle 2 fixedly coupled to the scraper blade 1 is a portion of the multifunctional scraper to be gripped by a hand, facilitating an operator's grip and use.

Differing from existing scrapers, the multifunctional scraper provided in the present embodiment further includes a tool receptacle 3 and a second tool 4. The tool receptacle 3 is provided on the handle 2 and is adapted to the second tool 4 in terms of shape and size. The second tool 4 is movably inserted in the tool receptacle 3.

The tool receptacle 3 in the present embodiment is provided to accommodate the second tool 4 using in a space of the handle 2. Therefore, the tool receptacle 3 is provided in a body of the handle 2. The tool receptacle 3 may be formed integrally with the handle 2, or may be later formed in the handle 2 by machining, as long as the second tool 4 can be received while not affecting the operator's comfort when gripping the handle 2 with a hand.

For example, as shown in FIG. 1, the tool receptacle 3 is provided in a middle portion of the handle 2. Of course, the tool receptacle 3 provided in the present application may also be provided elsewhere in the handle 2, e.g., at a trailing end of the handle 2, along an axial direction of the handle 2, or along a transverse direction of the handle 2. The method of provision may be as described previously, so a further description is omitted.

The tool receptacle 3 is intended mainly to accommodate the second tool 4, so it shall be adapted to the second tool 4 to be accommodated in terms of shape, size, depth, opening width and other dimensions. For example, the second tool 4 may be a Phillips screwdriver bit. Of course, it is also possible to, as needed, place another tool suitable to be placed in the handle 2, such as a knife blade, a tape measure or a screwdriver bit in another shape.

Therefore, by providing, in the handle 2 of the multifunctional scraper, the tool receptacle 3 and disposing the second tool 4 such as a screwdriver bit or a knife blade, it is possible to make the operator such as a painter able to conveniently carry, during operation, the second tool 4 and rapidly pick up or stow it. Therefore, the second tool 4 is movably inserted in the tool receptacle 3, and in order to achieve this movable insertion, a non-fastening manner such as friction created by surface contact between surfaces of the second tool 4 and the tool receptacle 3, snap elements or the like can be utilized, while requiring the tool receptacle 3 to be adapted to the second tool 4 in terms of size and shape.

The operator, when performing a scraping or shoveling operation using the multifunctional scraper, upon needing to use the second tool 4 such as a screwdriver bit or knife blade, can take the second tool 4 out of the handle 2, and after the use, put the second tool 4 back into the tool receptacle 3 in the handle 2, making access and use convenient and loss not easy to happen.

The second tool 4 in the multifunctional scraper provided in the present application is movably inserted in the tool receptacle 3. Considering the second tool 4 and/or the handle 2 is/are mostly made of a metallic material, a plastic or the like, in order to increase friction and guarantee, to a certain extent, relative stability of the second tool 4 placed in the tool receptacle 3, the present embodiment can employ a corresponding anti-slip measure. For example, on at least one inner wall of the tool receptacle 3, a damping mechanism is provided. For example, the damping mechanism may be provided at the bottom of the tool receptacle 3. For example, the damping mechanism may be an elastic snap element, or a magnetic element, or an anti-slip silicone coating.

For example, the elastic snap element may be disposed at the bottom or on an inner side wall of the tool receptacle 3. The magnetic element may be magnetic steel, wherein the magnetic steel may also be referred to as a magnet, and the magnetic element is disposed at the bottom of the tool receptacle 3. The anti-slip silicone coating is positioned on at least one inner wall of the tool receptacle 3. For example, the anti-slip silicone coating is positioned on a bottom surface, an inner circumferential surface or all the inner surfaces of the tool receptacle 3. Of course, other anti-slip materials or measures are also possible, and this can additionally enhance the utility and convenience of use of the multifunctional scraper provided in this application.

In another embodiment of the present application, the second tool 4 placed in the tool receptacle 3 may also be a Phillips screwdriver bit, or be a knife blade, or another tool.

For example, when the second tool 4 is a Phillips screwdriver bit or a knife blade, the tool receptacle 3 is provided in a middle portion of the handle, and the Phillips screwdriver bit or knife blade is movably inserted in the tool receptacle 3. When to be used, the Phillips screwdriver bit or knife blade can be taken out of the tool receptacle 3. In order to make the Phillips screwdriver bit or knife blade placed in the tool receptacle 3 not easy to slip off, on at least one inner wall of the tool receptacle 3, a damping mechanism is provided. For example, the damping mechanism may be a protruding snap element, or a magnetic element, or an anti-slip silicone coating, such as a protruding elastic snap element integrally formed with at least one inner wall of the tool receptacle 3, or a damping mechanism in another form, as long as it has a relatively fixing effect on the Phillips screwdriver bit or knife blade placed in the tool receptacle 3.

In another embodiment of this application, a linear screwdriver bit or a reversible bit is also a type of commonly used hand tool and may also be placed, as the second tool, in the tool receptacle 3 in the multifunctional scraper provided in the present embodiment. For example, the tool receptacle 3 transversely extends through the handle 2 and forms a linear through hole. Due to the transverse extension, the number of the tool receptacles 3 may be either one or more than one, e.g., two or three, depending principally on a length of the handle 2 as well as a size of the screwdriver bit. The linear screwdriver bit is also movably inserted in the tool receptacle 3, i.e., transversely extending through the through hole in the handle 2. Because of the through hole structure, the linear screwdriver bit, after being placed in the through hole, can be conveniently removed from either side of the through hole.

In another embodiment of this application, in order to additionally increase the spatial utilization, it is also possible to provide, at the trailing end of the handle 2, a tool receptacle along a longitudinal direction of the handle 2. For example, the trailing end of the handle 2 is provided thereat with the tool receptacle 3 along the longitudinal direction of the handle 2, and the trailing end of the handle 2 is also provided thereat with an end cap, the end cap threadedly coupled to the handle 2. The end cap, when tightened on the handle, will delimit, together with the longitudinal tool receptacle 3, an enclosed cavity, and the linear screwdriver bit can be placed in the cavity. When there is a need to use the linear screwdriver bit placed in the aforementioned cavity, it is possible to turn and open the end cap and take it out for use. As described in this specification, the linear screwdriver bit refers to a screwdriver bit in a linear shape with bit working portions at both ends. The two bit working portions may be identical. Of course, they may also be different.

In the multifunctional scraper provided in the present embodiment, the second tool 4, apart from the above introduced and explained Phillips screwdriver bit, knife blade or linear screwdriver bit, may also be an L-shaped bit tool or a hammer.

When the second tool 4 is an L-shaped bit or a hammer, the tool receptacle 3 is arranged to be adapted to the L-shaped tool or hammer in terms of size and shape, and the L-shaped bit is movably inserted in the tool receptacle. As described in the present embodiment, the L-shaped bit is a bit tool component in a shape like L and with working portions at both ends, one of which is a screwdriver bit and the other is a crowbar claw. As described in the present embodiment, the hammer is a type of commonly used hand tool and also has two ends, one of which is a hammer working portion that can utilize its own gravity to strike an object, and the other may be arranged as a screwdriver bit. For example, the screwdriver bit is movably fixed.

In the multifunctional scraper provided in the present embodiment, when the second tool 4 is inserted in the tool receptacle 3, in order to allow more convenient removal, it is possible to provide, around an externally exposed end of the tool receptacle 3, a curved depression. For example, the curved depression is formed. It is to be particularly noted that, as described in the present embodiment, the curved depression refers to a curved depression formed by additionally removing, by machining, the material of the handle 2 around the externally exposed end of the tool receptacle 3. The curved depression can make part of an interface of the second tool 4, especially a location allowing convenient access by the operator, exposed. Such a profile enables the operator to more conveniently pull and remove the second tool 4 from the tool receptacle 3.

In another embodiment of this application, when the second tool 4 is fabricated from a material made of steel, it is also possible to embed, at the bottom of the tool receptacle 3, a magnetic element, such as magnetic steel, so that a magnetic force from the magnetic element attracts and fixes the second tool 4 in the tool receptacle 3.

In addition, tape measures are also a kind of measuring tools commonly used in the fields of building construction, engineering decoration, etc. The multifunctional scraper of this application can also integrate the functionality of a tape measure into a scraper. When the second tool 4 is a tape measure, the tool receptacle 3 is provided at the trailing end of the handle 2, and the tape measure is movably inserted in the tool receptacle 3 at the trailing end of the handle 2.

Below, additionally in connection with particular second tools, the multifunctional scraper provided in the present application will be further described.

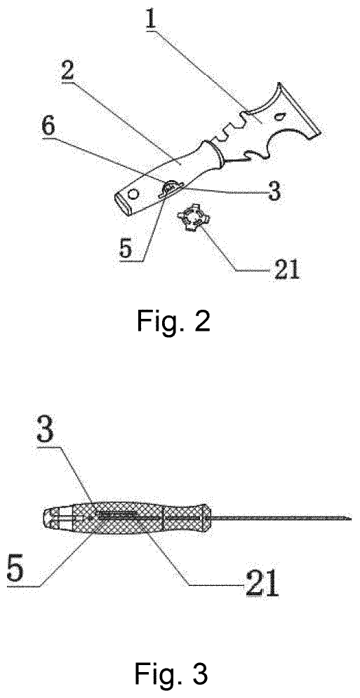

Referring to FIG. 2, a schematic exploded view of the structure of a multifunctional scraper of another embodiment of the present application, the multifunctional scraper provided in this embodiment includes a scraper blade 1, a handle 2 and a Phillips screwdriver bit 21. The Phillips screwdriver bit 21 is a second tool, and a middle portion of the handle 2 is provided with a tool receptacle 3. The tool receptacle 3 is adapted to the Phillips screwdriver bit 21 in terms of shape and size. For example, as shown in FIG. 3, the Phillips screwdriver bit 21 is movably inserted in the tool receptacle 3.

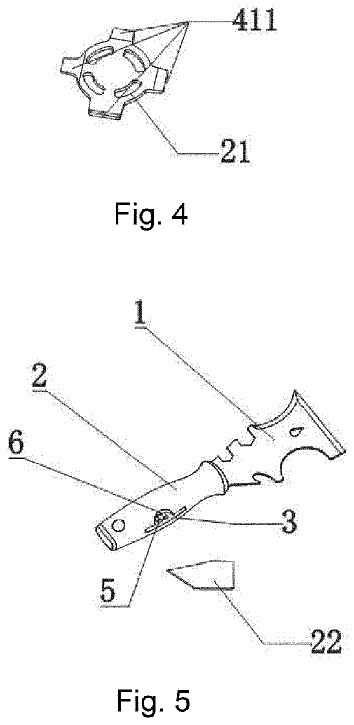

The Phillips screwdriver bit 21 may be as shown in FIG. 4, and the Phillips screwdriver bit 21 refers to a screwdriver bit with four Phillips bit working portions 211 directed toward four different perpendicular directions. Each Phillips bit working portion 211 may have a different function, in order to provide the operator with more options and greater convenience.

On an inner wall of the tool receptacle 3, a protruding snap element 5 is provided. For example, the protruding snap element 5 is integrally formed and can relatively securely lodge the Phillips screwdriver bit 21 received in the tool receptacle 3, preventing the Phillips screwdriver bit 21 from slipping out of the tool receptacle 3.

In order to relatively conveniently remove by pulling or place the Phillips screwdriver bit 21 from or back into the tool receptacle 3, around an externally exposed end of the tool receptacle 3, a curved depression 6 is provided. For example, the curved depression 6 is formed by a cutting process.

In order to additionally secure the Phillips screwdriver bit 21 placed in the tool receptacle 3, on a side wall of the tool receptacle 3, an anti-slip silicone coating is coated, which can increase friction between a surface of the tool receptacle 3 and a surface of the Phillips screwdriver bit 21, preventing the Phillips screwdriver bit 21 from easily dislodging from the tool receptacle 3.

Thus, the operator, when using the multifunctional scraper provided in the present embodiment, upon needing to use the Phillips screwdriver bit 21, can take it out of the handle 2 for use.

Referring to FIG. 5, a schematic exploded view of the structure of a multifunctional scraper of a further embodiment of the present application, the multifunctional scraper provided in the present embodiment includes a scraper blade 1, a handle 2 and a knife blade 22. The knife blade 22 is a second tool, and a middle portion of the handle 2 is provided with a tool receptacle 3. The tool receptacle 3 is adapted to the knife blade 22 in terms of shape and size. The knife blade 22 is movably inserted in the tool receptacle 3.

On an inner wall of the tool receptacle 3, a protruding snap element 5 is provided. For example, the protruding snap element 5 is integrally formed and can relatively securely lodge the knife blade 22 placed in the tool receptacle 3 and prevent the knife blade 22 from slipping out of the tool receptacle 3.

In order to relatively conveniently remove by pulling or place the knife blade 22 from or back into the tool receptacle 3, around an externally exposed end of the tool receptacle 3, a curved depression 6 is provided. For example, the curved depression 6 is formed by cutting around the externally exposed end of the tool receptacle 3.

In order to additionally secure the knife blade 22 placed in the tool receptacle 3, on a side wall of the tool receptacle 3, an anti-slip silicone coating is provided, which can increase friction between a surface of the tool receptacle 3 and a surface of the knife blade 22, preventing the knife blade 22 from easily dislodging from the tool receptacle.

The operator, when using the multifunctional scraper provided in the present embodiment, upon needing to use the knife blade 22, can take it out of the handle for use. This can provide the operator with more options and greater convenience.

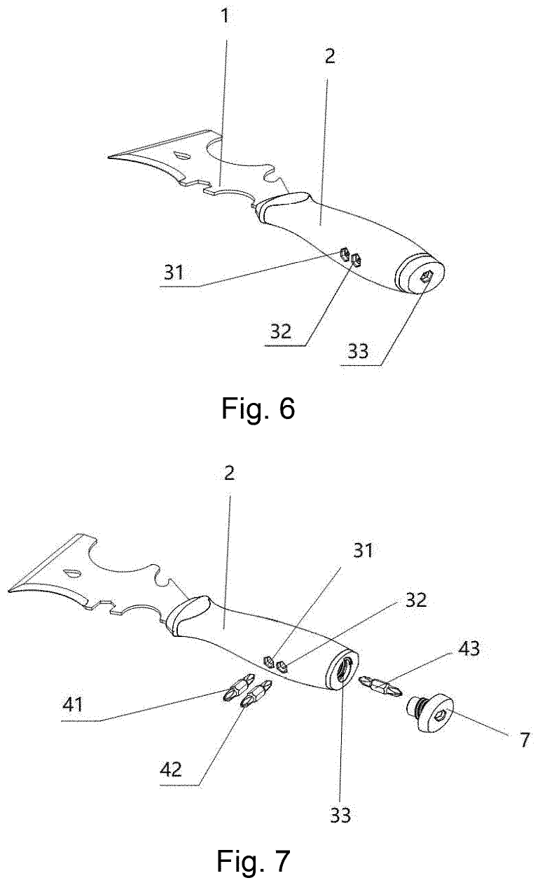

As shown in FIG. 6, a schematic diagram showing the structure of a multifunctional scraper according to a further embodiment of the present application, the multifunctional scraper provided in the present embodiment includes a scraper blade 1 and a handle 2. The handle 2 is provided with three tool receptacles, i.e., one first tool receptacle 31 and one second tool receptacle 32, both transversely extending through the handle 2, and one third tool receptacle 33 provided at a trailing end of the handle 2 along the longitudinal direction of the handle 2.

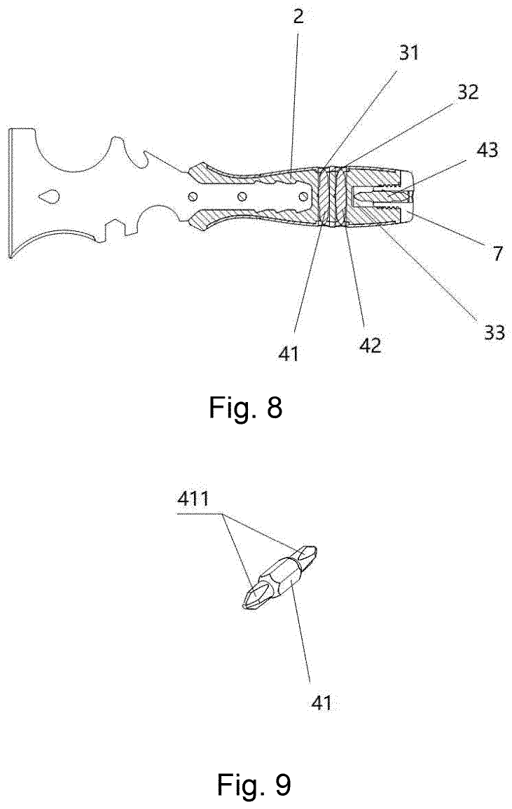

As shown in FIG. 7 and FIG. 8, the first tool receptacle 31, the second tool receptacle 32 and the third tool receptacle 33 may accommodate therein the first linear screwdriver bit 41, the second linear screwdriver bit 42 and the third linear screwdriver bit 43, respectively.

For example, the first tool receptacle 31 and the second tool receptacle 32 transversely extend through the handle 2 and form linear through holes. The first linear screwdriver bit 41 and the second linear screwdriver bit 42 are movably inserted in the first tool receptacle 31 and the second tool receptacle 32, respectively, i.e., transversely extending through the through holes in the handle 2.

Because of the through hole structures, the first linear screwdriver bit 41 and the second linear screwdriver bit 42, after being received respectively in the through holes, can be conveniently removed from either side of the through holes.

Additionally, as shown in FIG. 7, at the trailing end of the handle 2, an end cap 7 is provided. For example, the end cap 7 may be threadedly coupled to the trailing end of the handle 2. For example, the end cap 7 is threadedly engaged with an inner wall of the third tool receptacle 33 at the trailing end of the handle 2. Alternatively, the end cap 7 is secured against the inner wall of the third tool receptacle 33 at the trailing end of the handle 2 by an elastic element.

The end cap 7, when tightened at the trailing end of the handle 2, will delimit, together with the longitudinal third tool receptacle 33, an enclosed cavity, and in this cavity, the third linear screwdriver bit 43 can be placed. When there is a need to use the third linear screwdriver bit 43 placed in the aforementioned cavity, it is possible to turn and open the end cap 7 and take it out for use.

In order to additionally secure the first linear screwdriver bit 41, the second linear screwdriver bit 42 and the third linear screwdriver bit 43 that are placed in the first tool receptacle 31, the second tool receptacle 32 and the third tool receptacle 33, on the inner walls of the first tool receptacle 31, the second tool receptacle 32 and the third tool receptacle 33, anti-slip silicone coatings are provided. For example, the anti-slip silicone coatings are formed by a coating process.

As described in the present embodiment, the first linear screwdriver bit 41, the second linear screwdriver bit 42 and the third linear screwdriver bit 43 have identical structures and are all linearly-shaped screwdriver bits. For example, the first linear screwdriver bit 41 is described as an example. As shown in FIG. 9, the first linear screwdriver bit 41 has bit working portions 411 at both ends. The two bit working portions 411 have the same or different functions. For example, the bit working portions 411 at both ends of the first linear screwdriver bit 41 may be both Phillips screwdriver bit tips. Alternatively, one of them is a Phillips screwdriver tip, and the other is a straight screwdriver tip.

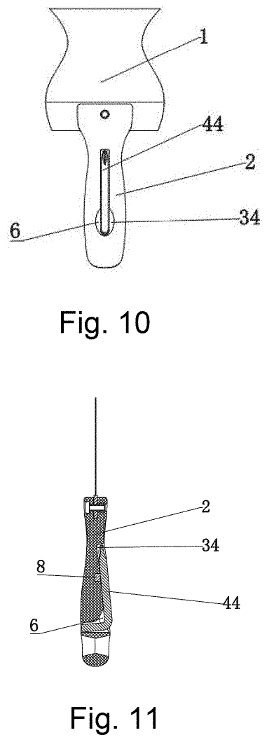

As shown in FIG. 10, a schematic diagram showing the structure of a multifunctional scraper of a further embodiment of the present application, the multifunctional scraper provided in the present embodiment includes a scraper blade 1, a handle 2 and an L-shaped bit tool 44. The L-shaped bit tool 44 is a second tool, and a middle portion of the handle 2 is provided with a tool receptacle 34. Wherein, the tool receptacle 34 is adapted to the L-shaped bit tool 44 in terms of shape and size. The L-shaped bit tool 44 is movably inserted in the tool receptacle 34.

As shown in FIG. 11, at the bottom of the tool receptacle 34, a magnetic element 8 is embedded. The magnetic element 8 may be magnetic steel, and the magnetic element 8 can utilize its attractive magnetic force to attractively retain the L-shaped bit tool 44 placed in the tool receptacle 34, thus effectively avoiding the L-shaped bit tool 44 from slipping out of the tool receptacle 34.

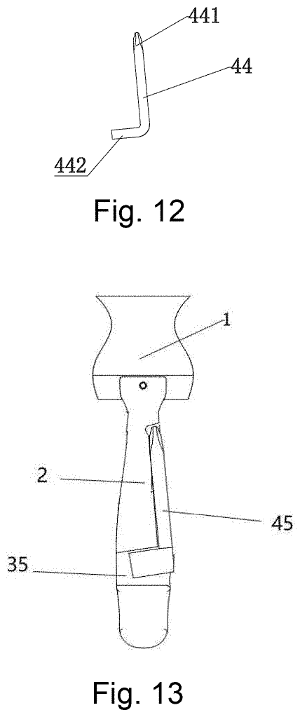

The L-shaped bit tool 44 in the present embodiment may be as shown in FIG. 12, and the L-shaped bit tool 44 has a bit working portion 441 and a crowbar claw 442 at its both ends. For example, the bit working portion 441 may be a Phillips screwdriver tip or a straight screwdriver tip.

In order to additionally secure the L-shaped bit tool 44 placed in the tool receptacle 34, on an inner wall of the tool receptacle 34, an anti-slip silicone coating is provided, for example, by coating the anti-slip silicone coating on the inner wall of the tool receptacle 34.

In order to relatively conveniently remove by pulling or place the L-shaped bit tool 44 from or back into the tool receptacle 34, around an externally exposed end of the tool receptacle 34, a curved depression 6 is provided. For example, around the externally exposed end of the tool receptacle 3, the curved depression 6 is formed by cutting.

As shown in FIG. 13, a schematic cutaway view of the structure of a multifunctional scraper according to a further embodiment of the present application, the multifunctional scraper of the present embodiment includes a scraper blade 1, a handle 2 and a hammer 45. Wherein, the hammer 45 is a second tool, and a middle portion of the handle 2 is provided with a tool receptacle 35. The tool receptacle 35 is adapted to the hammer 45 in terms of shape and size. The hammer 45 is movably inserted in the tool receptacle 35.

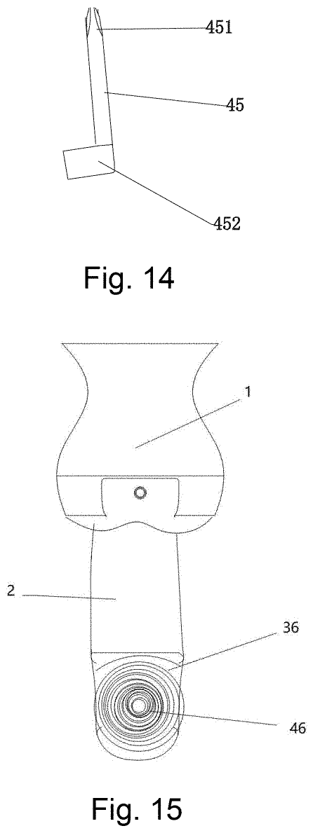

The hammer 45 in the present embodiment may be as shown in FIG. 14, and the hammer 45 has, at both ends, a screwdriver bit 451 and a hammer working portion 452. For example, the screwdriver bit 451 may be a Phillips screwdriver tip or a straight screwdriver tip.

In order to additionally secure the hammer 45 placed in the tool receptacle 35, on an inner wall of the tool receptacle 35, an anti-slip silicone coating is provided, for example, by coating the anti-slip silicone coating on the inner wall of the tool receptacle 35.

As shown in FIG. 15, a schematic diagram showing the structure of a multifunctional scraper of a further embodiment of the present application, the multifunctional scraper provided in the present embodiment includes a scraper blade 1, a handle 2 and a tape measure 46. Wherein, the tape measure 46 is a second tool, and at a trailing end of the handle 2, a tool receptacle 36 is provided. The tool receptacle 36 is adapted to the tape measure 46 in terms of shape and size. The tape measure 46 is movably inserted in the tool receptacle 36.

In order to additionally secure the tape measure 46 placed in the tool receptacle 36, on an inner wall of the tool receptacle 36, an anti-slip silicone coating is provided, for example, by coating the anti-slip silicone coating on the inner wall of the tool receptacle 36.

Hereinabove, the multifunctional scraper provided in the present application has been detailed and introduced. Specific examples are presented herein to explain the principles and embodiments of the multifunctional scraper provided in this application, and the description of the foregoing embodiments is intended only to help understand the method of this application and its core concept. It should be noted that, for those of ordinary skill in the art, without departing from the principles of this application, a number of improvements and modifications can be made. These improvements and modifications also fall within the protection scope of the claims of this application.

1. A combination tool, characterized in comprising:
a first tool component comprising, coupled to each other, a working portion and a grip portion, wherein the grip portion is provided with a tool receptacle;
a second tool component, the second tool component detachably disposed in the tool receptacle; and
a damping mechanism for preventing the second tool component from accidentally disengaging from the first tool component.

2. The combination tool according to claim 1, characterized in that:
the damping mechanism comprises a protrusion disposed on at least one inner wall of
the tool receptacle so that the second tool, when inserted in the tool receptacle, can be stopped by the protrusion; or
the damping mechanism comprises an anti-slip coating provided on at least one inner wall of the tool receptacle; or
the damping mechanism comprises a magnetic element embedded in the grip portion.

3. The combination tool according to claim 1, characterized in that:
the damping mechanism comprises an elastic mechanism provided on the second tool so that, when the second tool is inserted in the tool receptacle, the damping mechanism can abut against an inner wall of the tool receptacle to prevent the second tool from accidentally disengaging from the tool receptacle.

4. The combination tool according to claim 1, characterized in that:
the tool receptacle is provided in a side surface and/or at a trailing end of the grip portion.

5. The combination tool according to claim 4, characterized in that:
the tool receptacle has a long arm extending longitudinally on a surface of the grip portion and a short arm extending transversely toward the interior of the grip portion, forming an L-shaped cavity.

6. The combination tool according to claim 5, characterized in that:
the second tool is retractably disposed in the tool receptacle.

7. The combination tool according to claim 6, characterized in that:
the tool receptacle is provided, around an externally exposed end thereof, with a depression for facilitating retraction of the second tool.

8. The combination tool according to claim 4, characterized in that:
the tool receptacle is a longitudinal cavity that is open at the trailing end of the grip portion.

9. The combination tool according to claim 8, characterized in further comprising:
an end cap, the end cap openably and closably mounted at an opening of the tool receptacle.

10. The combination tool according to claim 1, characterized in that:
the first tool component is a scraper, the working portion is a scraper blade, the grip portion is a handle and the grip portion is secured to a leading end of the working portion; and
the second tool component is one or more of the following tools: a Phillips bit, a knife blade, an L-shaped bit, a hammer, a linear bit and a tape measure.
